(19) United States
(12) Patent Application Publication
(10) Pub. No.: US 2011/0298575 A1
(43) Pub. Date: Dec. 8, 2011

(54) MAGNETIC SHUNT, MAGNETIC SHUNT ARRANGEMENT AND POWER DEVICE

(75) Inventors: Bogdan CRANGANU-CRETU, Fislisbach (CH); Jasmin Smajic, Schofflisdorf (CH); Henrik Nordborg, Baden-Dattwil (CH)

(73) Assignee: ABB RESEARCH LTD, Zurich (CH)

(21) Appl. No.: 13/211,093

(22) Filed: Aug. 16, 2011

Related U.S. Application Data
(63) Continuation of application No. PCT/EP2010/051895, filed on Feb. 16, 2010.

(30) Foreign Application Priority Data
Feb. 18, 2009 (EP) 09153106.1

(51) Int. Cl. H01F 27/36

(52) U.S. Cl. 336/84 M

(57) ABSTRACT

A magnetic shunt is provided for magnetic shielding of a power device (e.g., a power transformer). The magnetic shunt includes magnetic flux collectors that are magnetically connected by a magnetically permeable bridge. The bridge is arranged between the magnetic flux collectors with one magnetic flux collector being placed at each end of the bridge. The cross-section of the magnetic flux collectors is larger than the cross-section of the bridge, and the magnetic shunt forms a single structural unit. A magnetic shunt arrangement and a power device which include magnetic shunts according to the present disclosure are also provided.

### RELATED APPLICATION

This application claims priority as a continuation application under 35 U.S.C. §120 to PCT/EP 2010/0051895. which was filed as an International Application on February 16, 2010 designating the U.S., and which claims priority to European Application 09153106.1 filed in Europe on Feb. 18, 2009. The entire contents of these applications are hereby incorporated by reference in their entireties.

### FIELD

The present disclosure relates to a magnetic shunt for magnet shielding of a power device, to a magnetic shunt arrangement for magnetic shielding of a power device, and to a power device.

### BACKGROUND INFORMATION

Magnetic shielding (also called magnetic screening) is employed to protect a certain object that has a certain volume, such as, for example, a power (electrical) device (e.g., a power transformer) from magnetic fields such as, for example, stray magnetic fields. To achieve magnetic shielding/screening, there are currently two known solutions (Ch. Yongbin, Y. Junyou, Y. Hainian, T. Renyuan, “Study on Eddy Current Losses and Shielding Measures in Large Power Transformers”, IEEE Transactions on Magnetics, Vol. 30, No. 5, 1994, and K. Karsai, D. Kerenyi, L. Kiss, “Large Power Transformers”, Elsevier, Amsterdam—Oxford—New York, 1987, J. Turowski, X. M. Lopez-Fernandez, A. Soto, D. Souto, “Stray losses Control in Core- and Shell-Type Transformers”, Proceedings of ARWtr 2007 Advanced Research Workshop on transformers, Baiona, Spain, Edited by. X. M Lopez-Fernadez, ISBN 978-84-612-0115-0, pp. 56-68). According to one solution, electromagnetic shielding is realized by conductive screens (also called conductive shields) that consist of highly-conductive materials with low magnetic permeability (see, e.g., U.S. Pat. No. 3,827,018). The other solution employs so-called magnetic shunts that include magnetically highly permeable materials with anisotropically low electric conductivity (see U.S. Pat. No. 3,091,744). This solution is also referred to as magnetic shunting.

Power losses induced by or resulting from a stray magnetic field become more crucial with increasing units of power of a power device. Stray magnetic fields are therefore not only a technical problem, but also an economic one, since the capitalization values that correspond to the induced load losses represent a significant part of the costs of a power device, such as a power transformer (see R. Komulainen, H. Nordman, “Loss evaluation and the use of magnetic and electromagnetic shields in transformers”, CIGRE International conference on Large and High Voltage Electric Systems, 1988 Session, paper ID: 12-03). On the other hand, the current market situation is dominated by relatively high prices for the raw material of a power device (e.g., a power transformer) which calls for material reduction in the construction of power devices. Material reduction may, however, lead to an increase in losses.

In large power devices such as power transformers, the existence of a stray magnetic flux is usually inevitable and cannot be entirely prevented just by careful and thorough design of the power device (see Ch. Yongbin, Y. Junyou, Y. Hainian, T. Renyuan, “Study on Eddy Current Losses and Shielding Measures in Large Power Transformers”, IEEE Transactions on Magnetics, Vol. 30, No. 5, 1994, K. Karsai, D. Kerenyi, L. Kiss, “Large Power Transformers”, Elsevier, Amsterdam—Oxford—New York, 1987). In the case of power transformers, their energizing high- and low-voltage windings are usually connected to the environment via a system of conducting busbars, where the busbars are one of the main sources of stray magnetic flux (see K. Karsai, D. Kerenyi, L. Kiss, “Large Power Transformers”, Elsevier, Amsterdam—Oxford—New York, 1987, Y. Junyou, T. Renyuan, W. Chengyuan, Z. Meiwen, “New Preventive Measures against Stray Field of Heavy Current Carrying Conductors”, IEEE Transactions on Magnetics, Vol. 32, No. 3, 1996). Through careful design of the busbars, the stray magnetic field may sometimes be significantly reduced but, however, not eliminated (see Y. Junyou, T. Renyuan, L. Yan, Ch. Yongbin, “Eddy Current Fields and Overheating Problems Due to Heavy Current Conductors”, IEEE Transactions on Magnetics, Vol. 30, No. 5, 1994). Furthermore, part of the magnetic flux that is created by the windings is generally not captured by the core of the power transformer (even in the case of a perfect ampere-turns balance) but forms a stray magnetic field that affects metallic parts located in its path, thus representing the other major source of stray magnetic fields (see Y. Junyou, T. Renyuan, L. Yan, Ch. Yongbin, “Eddy Current Fields and Overheating Problems Due to Heavy Current Conductors”, IEEE Transactions on Magnetics; Vol. 30, No. 5, 1994).

Having a certain level of stray magnetic fields in a power transformer leads to a certain level of corresponding eddy currents in the affected conductive ferromagnetic (or not ferromagnetic) bodies of the power transformer such as, for example, the transformer tank, where the eddy currents are induced through the stray magnetic flux. A transformer tank is usually made of rather cheap ferromagnetic steel. The induced eddy currents reduce the efficiency of the power device and further contribute to a possible overheating of the power device, thereby at the same time increasing the risk of a local temperature rise, for example, the appearance of so-called hot-spots (see K. Karsai, D. Kerenyi, L. Kiss, “Large Power Transformers”, Elsevier, Amsterdam—Oxford—New York, 1987). Known techniques have not appropriately remedied the issue of overheating and hot-spots that can significantly reduce the life time of a newly installed power device—for example, by leading to gassing phenomena in the employed cooling oil and thus to loss of dielectric strength. Suitable and affordable tools for thermal scanning of a power device are available in the form of infrared photo cameras which come in various types, that is, most expensive power devices are today checked for overheating after their installation. To avoid overheating and hot-spots, measures and tools for temperature reduction and for keeping the operating temperature of a power device below a certain limit are an important issue today (see K. Karsai, D. Kerenyi, L. Kiss, “Large Power Transformers”, Elsevier, Amsterdam—Oxford—New York, 1987).

While losses due to eddy-currents induced by stray magnetic flux are not the only reason for overheating and/or hot-spots of a power device (e.g., a power transformer) they represent one of the main contributors to the occurrence of overheating/hot-spots. To avoid the penetration of stray magnetic fields into ferromagnetic conductive bodies of a power device, the above-mentioned magnetic screens in the form of conductive shields or magnetic shunts may be used. The efficiency of the magnetic screens critically depends on their design.

Exemplary embodiments of the present disclosure are focused on magnetic shunts, such as magnetic screens that are made with a magnetically highly permeable material that is basically electrically non-conductive. Magnetic screens with these properties can be relatively easily produced by rolling and pressing tiny oxidized films of magnetically highly permeable iron as described in K. Karsai, D. Kerenyi, L. Kiss, “Large Power Transformers”, Elsevier, Amsterdam—Oxford—New York, 1987. The oxidized layers prevent the conduction of electric current in the desired direction (e.g., the direction of the eddy-currents induced by a stray magnetic field), thereby achieving the required non-conductive property. After the magnetic rolls have been pressed, relatively long magnetic shunts can be produced with the required cross-section. Magnetic shunts with quasi-optimal dimensions, for example, thickness, are described in Ch. Yongbin, Y. Junyou, Y. Hainian, T. Renyuan, “Study on Eddy Current Losses and Shielding Measures in Large Power Transformers”, IEEE Transactions on Magnetics, Vol. 30, No. 5, 1994; B. Cranganu-Cretu, J. Smajic and G. Testin, “Usage of Passive Industrial Frequency Magnetic-Field Shielding for Losses Mitigation: A Simulation Approach”, Proceedings of ARWtr 2007 Advanced Research Workshop on Transformers, Baiona, Spain, 2007, Edited by. X. M Lopez-Fernadez, ISBN 978-84-612-0115-0, pp. 325-330; K. Karsai, D. Kerenyi, L. Kiss, “Large Power Transformers”, Elsevier, Amsterdam—Oxford—New York, 1987, S. A. Holland, G. P. O'Connel, L. Haydock, “Calculating Stray Losses In Power Transformers Using Surface Impedance With Finite Elements”, IEEE Transactions On Magnetics, Vol. 28, No. 2, Mar. 1992, pp. 1355-1358, with the geometrical characteristics of the employed magnetic shunts depending on the object to be shielded.

Usually, the size and shape of a single magnetic shunt is standardized and several standardized magnetic shunts are combined in a shunting arrangement/system that is then placed between the source of the stray field and the object to be shielded. For example, to protect a tank wall of a power transformer from a stray magnetic field, the magnetic shunts can be arranged in a row and placed parallel to the tank wall. At the same time, the axes of the magnetic shunts run parallel to the estimated direction of the expected stray magnetic field to reduce the losses due to eddy currents induced in the tank wall (see Ch. Yongbin, Y. Junyou, Y. Hainian, T. Renyuan, “Study on Eddy Current Losses and Shielding Measures in Large Power Transformers”, IEEE Transactions on Magnetics, Vol. 30, No. 5, 1994, K. Karsai, D. Kerenyi, L. Kiss, “Large Power Transformers”, Elsevier, Amsterdam—Oxford—New York, 1987).

As the shape of a single magnetic shunt is assumed to be standardized, it is possible to define an entire magnetic shunt arrangement/system as a combination of a given number of standardized magnetic shunts at given positions to efficiently protect an object to be shielded from an expected magnetic stray flux. The magnetic shunt arrangement/system can be designed by using the dimensional values obtained from solving a corresponding set of known analytically and/or empirically derived equations.

### SUMMARY

An exemplary embodiment provides a magnetic shunt for magnetic shielding of a power device. The exemplary magnetic shunt includes magnetic flux collectors, and a magnetically permeable bridge configured to magnetically connect the magnetic flux collectors and form the magnetic shunt as a single structural unit. The bridge is arranged between the magnetic flux collectors with one magnetic flux collector being placed at each end of the bridge, respectively. A cross-section of the magnetic flux collectors is larger than a cross-section of the bridge. The magnetic shunt is substantially concave towards magnetic field sources.

Exemplary embodiments of the present disclosure also provide a magnetic shunt arrangement and a power device including at least one magnetic shunt according to the present disclosure.

### BRIEF DESCRIPTION OF THE DRAWINGS

Additional refinements, advantages and features of the present disclosure are described in more detail below with reference to exemplary embodiments illustrated in the drawings, in which:

FIG. 1 shows a schematic drawing of a magnetic shunt in top view according to an exemplary embodiment of the present disclosure;

FIG. 2 shows a schematic drawing of a magnetic shunt in top view according to an exemplary embodiment of the present disclosure;

FIG. 3 shows a schematic drawing of a magnetic shunt in top view according to an exemplary embodiment of the present disclosure;

FIG. 4 shows a schematic drawing of a magnetic shunt in top view according to an exemplary embodiment of the present disclosure;

FIG. 5 shows a schematic drawing of a magnetic shunt with two parallel shunts in top view according to an exemplary embodiment of the present disclosure;

FIG. 6 shows a schematic drawing of a magnetic shunt in top view according to an exemplary embodiment of the present disclosure;

FIG. 7 shows a schematic drawing of a magnetic shunt with two parallel shunts in top view according to an exemplary embodiment of the present disclosure;

FIG. 8 shows a schematic drawing of a magnetic shunt in top view according to an exemplary embodiment of the present disclosure;

FIG. 9 shows a schematic drawing of a magnetic shunt in top view according to an exemplary embodiment of the present disclosure;

FIG. 10 shows a schematic drawing with the principle inner structure of the magnetic shunts shown in FIGS. 1 to 10 in top view according to an exemplary embodiment of the present disclosure;

FIGS. 11-13 show the embodiment of FIG. 1 in top view (FIG. 11), in perspective view (FIG. 12) and in side view (FIG. 13);

FIG. 14 shows a schematic representation of the topology that forms the basis for an optimization problem to be solved to find a magnetic shunt according to an exemplary embodiment of the present disclosure;

FIG. 15 shows the magnetic flux lines over the entire domain if no magnetic shunt is used according to an exemplary embodiment of the present disclosure;

FIG. 16 shows the magnetic flux lines over the entire domain if the magnetic shunt depicted in FIG. 1 is used according to an exemplary embodiment of the present disclosure;

FIG. 17 shows schematically a tank wall with no magnetic shunt according to an exemplary embodiment of the present disclosure;

FIG. 18 shows the corresponding induced power losses (in W/m³) in the tank wall according to the arrangement shown in FIG. 17 according to an exemplary embodiment of the present disclosure;

FIG. 19 shows schematically a tank wall with the magnetic shunt depicted in FIG. 9 according to an exemplary embodiment of the present disclosure;

FIG. 20 shows the corresponding induced power losses (in W/m³) in the tank wall according to the arrangement shown in FIG. 19 according to an exemplary embodiment of the present disclosure;

FIG. 21 shows schematically a tank wall with the magnetic shunt depicted in FIG. 1 according to an exemplary embodiment of the present disclosure;

FIG. 22 shows the corresponding induced power losses (in W/m³) in the tank wall according to the arrangement shown in FIG. 2 according to an exemplary embodiment of the present disclosure;

FIGS. 23-25 show a schematic partial representation of a power transformer with a magnetic shunt in top view (FIG. 23), in side view (FIG. 24) and in perspective view (FIG. 25) according to an exemplary embodiment of the present disclosure;

FIG. 26 shows schematically part of a power transformer with no magnetic shunt according to an exemplary embodiment of the present disclosure;

FIG. 27 shows the corresponding induced power losses (in W/m³) in the tank wall of the power transformer according to FIG. 26, in accordance with an exemplary embodiment of the present disclosure;

FIG. 28 shows schematically part of a power transformer with a known magnetic shunt arrangement;

FIG. 29 shows the corresponding induced power losses in the tank wall (in W/m³) of the power transformer according to FIG. 28,

FIG. 30 shows schematically part of a power transformer with a magnetic shunt arrangement according to an exemplary embodiment of the present disclosure; and

FIG. 31 shows the corresponding induced power losses (in W/m³) in the tank wall of the power transformer according to FIG. 30 according to an exemplary embodiment of the present disclosure.

The values given in the drawings are only exemplarily.

### DETAILED DESCRIPTION

Exemplary embodiments of the present disclosure provide a magnetic shunt, a magnetic shunt arrangement, and a power device by which magnetic shielding can be efficiently achieved.

An exemplary embodiment provides a magnetic shunt for magnetic shielding of a power device (e.g., a power transformer). The magnetic shunt includes magnetic flux collectors that are magnetically connected by a magnetically permeable bridge, wherein the bridge is arranged between the magnetic flux collectors with one magnetic flux collector being placed at each end of the bridge. The cross-section of the magnetic flux collectors is larger than the cross-section of the bridge, and the magnetic shunt forms a single structural unit. The cross-section is defined as a cutting at or about right angles to the longitudinal direction of a magnetic shunt (or a bridge, respectively) when the magnetic shunt is seen in top view.

Due to its larger cross-section, the magnetic flux collector at one end of the bridge of the magnetic shunt represents a lump piece of magnetic material that simply attracts the magnetic flux (e.g, stray magnetic flux) from the space/environment around. The attracted magnetic flux is then conducted by the bridge with the smaller cross-section from its one end to its other end, where the magnetic flux then leaves the magnetic shunt on the surface of the other lump piece of magnetic material given by the other magnetic flux collector. In accordance with an exemplary embodiment, the magnetic flux from the environment is advantageously collected by the magnetic flux collectors with the larger cross-section than the bridge. In accordance with an exemplary embodiment of the present disclosure, the cross-section of the magnetic flux collectors is therefore at least 10 times larger than the cross-section of the bridge.

The magnetic flux collectors—and hence the magnetic shunt according to exemplary embodiments of the present disclosure—are geometrically simple, easy to manufacture and significantly increase the efficiency of magnetic shielding against stray magnetic fields.

In accordance with an exemplary embodiment, the magnetic flux collectors and the bridge include or made with the same material. They can, for example, be produced by rolling and pressing tiny oxidized films of magnetically highly permeable iron as described above with reference to K. Karsai, D. Kerenyi, L. Kiss, “Large Power Transformers”, Elsevier, Amsterdam—Oxford—New York, 1987. The realization of the magnetic flux collectors and of the bridge between the collectors in the magnetic shunt, which is done with oxidized films of magnetically highly permeable iron, can be performed as laminations. Since the magnetic shunt according to exemplary embodiments of the present disclosure works by concentrating, or in other words, collecting the stray magnetic flux into the flux collectors, it is of outmost importance that the flux attacks the laminations in the direction where they encounter the smallest exposed surface—and hence will yield the least ohmic losses.

In accordance with an exemplary embodiment, the magnetic flux collectors of the magnetic shunt are not restricted to a particular shape. They can, for example, be spherical in shape and be placed at critical positions inside a power device, while being connected by a tiny magnetic wirelike bridge, so that stray magnetic fluxes produced by several different sources may be collected and guided into a specific, pre-defined direction. Of course, the magnetic flux collectors may be of different shape, for example, a cuboidal or parallelepiped shape, respectively.

An exemplary embodiment of the present disclosure provides a magnetic shunt arrangement for magnetic shielding of a power device (e.g., a power transformer) which includes at least two magnetic shunts according to the present disclosure. The magnetic shunts are arranged in a single row with the bridges spaced apart, and each flux collector is connected to the respective flux collector of the adjacent magnetic shunt that is located at the corresponding end of the respective bridge. In accordance with an exemplary embodiment, the magnetic flux collectors of the magnetic shunts of the magnetic shunt arrangement can form a frame of the magnetic shunt arrangement.

An exemplary embodiment of the present disclosure also provides a power device (e.g., a power transformer) which includes a magnetic core, a winding inductively coupled to the magnetic core, and a tank with tank walls. One or more magnetic shunts according to the present disclosure are provided and arranged, or a magnetic shunt arrangement according to the present disclosure is provided and arranged such that the bridges of the one or more magnetic shunts run parallel and are all placed at the same distance to the tank wall.

The magnetic shielding efficiency against stray magnetic fields can be significantly improved with the magnetic shunt, the magnetic shunt arrangement and the power device according to the exemplary embodiments of the present disclosure. The exemplary magnetic shunt according to the present disclosure is simple in construction and of low cost. It allows improvement of the shielding efficiency of three-dimensional objects with an arbitrary source of stray magnetic field (e.g., busbars and windings). Existing shunt systems/arrangements or power devices can be easily modified by introducing the magnetic shunt according to the disclosure.

FIGS. 1 to 10 each depict in top view an exemplary embodiment of a magnetic shunt 1 that is placed between a ferromagnetic conductive plate 2, representing, for example, the tank wall of a power transformer, and busbars 3. The conductive plate 2 is the object to be magnetically shielded by the magnetic shunt 1, and the busbars 3 are the source of the magnetic field. In accordance with an exemplary embodiment, the electrical conductivity a of the conductive plate 2 can be 6.66·10⁶ S/m and the magnetic permeability μᵣ can be 200. A phase current of, for example, 1000 A RMS (root mean square) with a frequency of 50 Hz runs through the busbars 3.

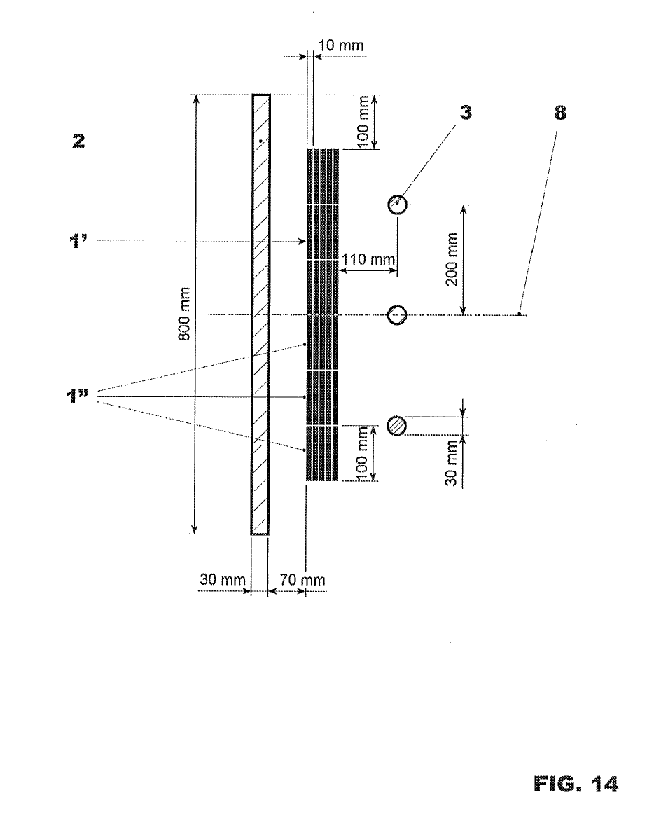

The magnetic shunt 1 includes a bridge 4 and two magnetic flux collectors 5. The bridge 4 connects the two magnetic flux collectors 5. The cross-section of each of the magnetic flux collectors 5 is larger than the cross-section of the bridge 4. Therefore, in accordance with an exemplary embodiment, all the magnetic shunts 1 depicted in FIGS. 1 to 10 are of non-uniform thickness. The magnetic shunt 1 is symmetrical in respect to a symmetry axis perpendicular to the conductive plate 2 and the busbars 3 (see also FIG. 14 and the description thereof). FIGS. 1 to 10 each show the simulated power losses induced in the conductive plate 2 by the magnetic field generated by the busbars 3, with increasing power losses from FIG. 1 to FIG. 9. The power losses have been simulated when solving the two-dimensional optimization problem described below. A rectangular box is shown in FIGS. 1 to 9 to emphasize one of the magnetic flux collectors. In FIGS. 1 to 4, 6, 8 to 9, the magnetic shunt 1 forms a single structural unit. In FIGS. 5 and 7, the magnetic shunt 1 is given by two separate units.

In FIG. 1, the cross-section of the bridge 4 is constant and the bridge 4 is not centered between the magnetic flux collectors 5 in the transverse direction (when seen in top view), but shifted towards conductive plate 2. In accordance with an exemplary embodiment, the cross-section of the bridge 4 is about one-fifth of the cross-section of the magnetic flux collector 5. The induced power loss for the depicted embodiment is 2.48 W.

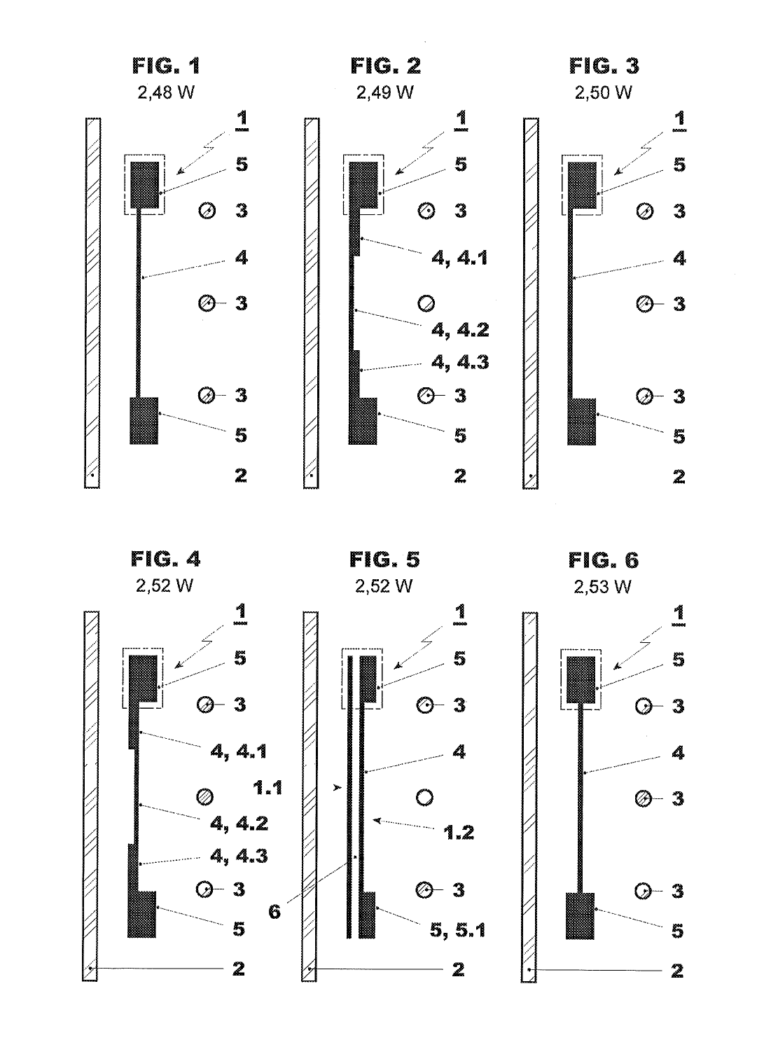

In FIG. 2, the magnetic flux collectors 5 are aligned with the bridge 4, where the aligned side of the magnetic shunt 1 faces the conductive plate 2. Furthermore, the bridge 4 includes three sections 4.1, 4.2 and 4.3 with one inner section 4.2 and two outermost sections 4.1 and 4.3, where the two outermost sections 4.1 and 4.3 are each located at an end of the bridge 4. The cross-section of the outermost sections 4.1 and 4.3 is larger than the cross-section of the inner section 4.2. The outermost sections 4.1 and 4.3 are aligned with the inner section 4.2 and the magnetic flux collectors 5. In accordance with an exemplary embodiment, the cross-section of the inner section 4.2 can be one-fourth of the cross-section of a magnetic flux collector 5, and the cross-section of each outermost section 4.1, 4.3 can be twice the cross-section of the inner section 4.2. Of course, there can be more than one inner section and more than two outermost sections. The induced power loss for the depicted embodiment is 2.49 W.

In FIG. 3, the magnetic flux collectors 5 are also aligned with the bridge 4. The aligned side of the magnetic shunt 1 faces the conductive plate 2. The cross-section of the bridge 4 is constant. In accordance with an exemplary embodiment, the cross-section of the bridge 4 can be about one-fourth of the cross-section of a magnetic flux collector 5. The induced power loss for the depicted embodiment is 2.50 W.

In FIG. 4, the bridge 4 has been mirrored along the longitudinal axis of the bridge 4 (when seen in top view) when compared to the exemplary embodiment of FIG. 2. That is, the outermost sections 4.1 and 4.3 are aligned with the magnetic flux collectors 5, but not with the inner section 4.2 on that side of the magnetic shunt 1 that faces the conductive wall 2. On that side of the magnetic shunt 1 that faces away from the conductive wall 2, the outermost sections 4.1 and 4.3 are aligned with the inner section 4.2, but not with the magnetic flux collectors 5. The induced power loss for the depicted embodiment is 2.52 W.

FIG. 5 depicts a magnetic shunt 1 in accordance with an exemplary embodiment of the present disclosure, wherein the magnetic flux collectors 5 and the bridge 4 are each divided by a longitudinal gap 6 into two separate parts, such that the magnetic shunt 1 is given by two separate units 1.1 and 1.2, the units 1.1 and 1.2 also representing magnetic shunts. The bridge 4 is aligned with the magnetic flux collectors 5 and faces the conductive plate 2. The induced power loss for the depicted embodiment is 2.52 W.

In FIG. 6, the bridge 4 is centered between the magnetic flux collectors 5. In accordance with an exemplary embodiment, the cross-section of the bridge 4 can be about one-fifth of the cross-section of a magnetic flux collector 5. The induced power loss for the depicted embodiment is 2.53 W.

The exemplary embodiment of FIG. 7 corresponds to the exemplary embodiment shown in FIG. 5 with a larger gap 6 and the cross-section of that part 5.1 of the magnetic flux collectors 5 that faces away from the conductive plate 2 having a smaller cross-section than in FIG. 5. The induced power loss for the depicted embodiment is 2.53 W.

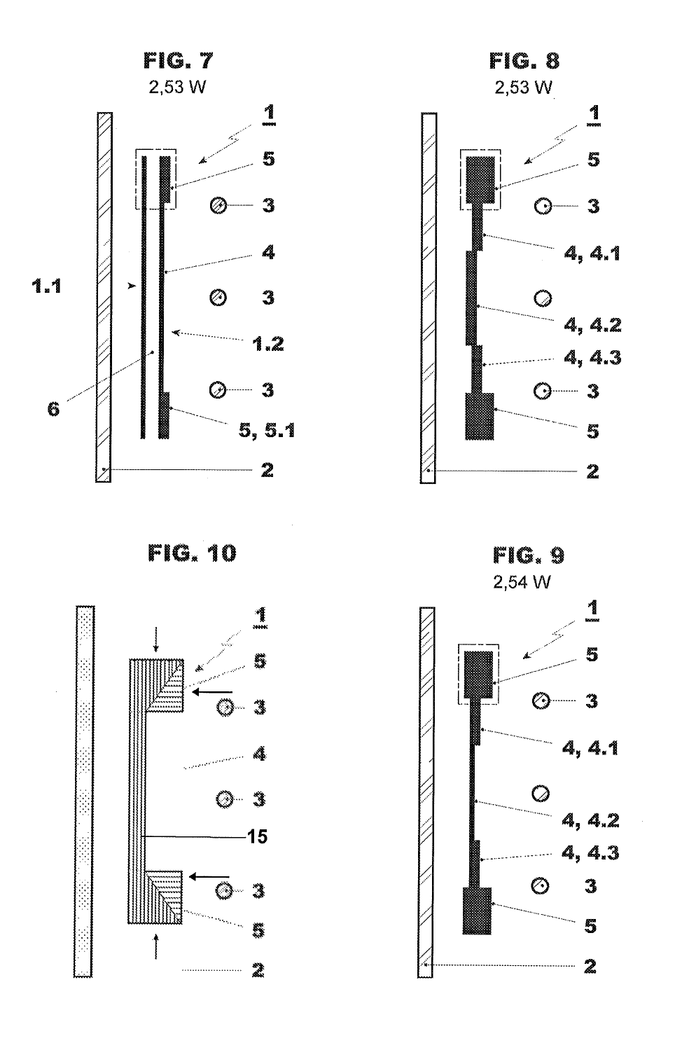

In FIG. 8, the bridge 4 includes three sections 4.1, 4.2, 4.3 of, for example, equal cross-section, namely one inner section 4.2 and two outermost sections 4.1 and 4.3 with each outermost section 4.1 and 4.3 being located at an end of the bridge 4. The inner section 4.2 is shifted sideways, for example, in the transverse direction of the magnetic shunt 1 (when seen in top view), with respect to the outermost sections 4.1 and 4.3 and closer to the conductive wall 2 than the outermost sections 4.1 and 4.3. The inner section 4.2 and the magnetic flux collectors 5 are aligned on that side of the magnetic shunt 1 that faces the conductive plate 2. Of course, there can be more than one inner section and more than two outermost sections. The induced power loss for the depicted embodiment is 2.53 W.

FIG. 9 corresponds to FIG. 2 with the bridge being shifted inwards, such that the magnetic flux collectors 5 are not aligned with the bridge 4, but the outermost sections 4.1 and 4.3 of the bridge 4 are aligned with the inner section 4.2 of the bridge 4 on that side that faces the conductive plate 2. The induced power loss for the depicted embodiment is 2.54 W.

FIG. 10 shows the inner structure of an exemplary embodiment of a magnetic shunt 1, having a laminated structure 15 of the bridge 4 and of the flux collector 5, 14. The laminated structure is shown for an exemplary cross section similar to the cross section shown in FIG. 3 but not limited to such cross section only. In accordance with an exemplary embodiment, the laminated structure 15 of the bridges 4 extends into the region of the magnetic flux collectors 5 and a part of the laminated structure 15 of the magnetic flux collectors 5 is oriented in an orthogonal direction to the structure 15 of the bridges. The effect of such structural composition of bridges 4 and collectors 5 is the flux impacts the laminations in the direction where they encounter the smallest exposed surface and will yield the least ohmic losses.

The exemplary embodiments shown in FIG. 1 to FIG. 10 have the characteristic of being substantially concave towards the busbars, for example, towards the magnetic field sources. This concave shape is a consequence of the function of magnetic flux collector 5 has. The stray magnetic flux is primarily directed towards the collecting flux collector 5 or the closed frame 14, which exhibits the biggest cross section and prevents saturation effects.

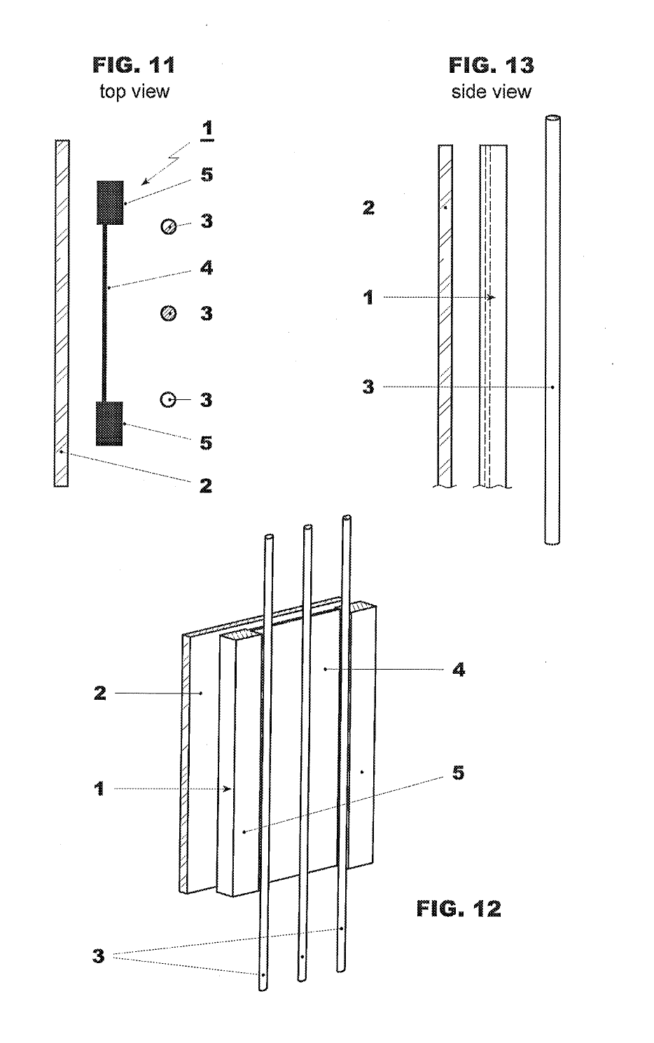

FIGS. 11-13 show, as an example, the embodiment depicted in FIG. 1 in top view (FIG. 11), in perspective view (FIG. 12) and in side view (FIG. 13). The height of the tank wall given by the conductive plate 2 and of the magnetic shunt 1 is, for example 1 m, whereas the conductors of the busbars 3 extend, for example, over 1.8 m. The properties of the conductive plate 2 and the magnetic shunt 1 are as described for FIGS. 1 to 10. The busbars 3 are centered with respect to the tank wall 2. The busbars 3 produce the magnetic field. The depicted configuration resembles the actual situation in a power transformer, where the energizing current is brought to the windings at the top of the power transformer. The exemplary embodiments of FIGS. 2 to 10 can be depicted analogously in perspective view and side view.

In accordance with an exemplary embodiment, to find a magnetic shunt according to the disclosure, including its dimensions, a topological optimization problem can be formulated, where the (sub-optimal) solutions of this optimization problem are among others the counter-intuitive embodiments of a magnetic shunt depicted in FIGS. 1 to 13 that all include magnetic flux collectors whose cross-section is larger than the cross-section of the bridge. In accordance with an exemplary embodiment, the topological optimization problem can be formulated as a three-dimensional optimization problem, but can also be formulated as simpler two-dimensional optimization problem.

The initial (top view) topology that forms the basis or starting point for the two-dimensional optimization problem is depicted in FIG. 14. It includes a ferromagnetic conductive plate 2, busbars 3 and a magnetic shunt 1′ (being the initial magnetic shunt 1′) that is placed between the conductive plate 2 and the busbars 3. The conductive plate 2 shall be magnetically shielded by the magnetic shunt 1′ from the magnetic field produced by the busbars 3. The dimensions in top view for the magnetic shunt 1′, the conductive plate 2 and the busbars 3 and their distances are exemplarily given in FIG. 14. The electrical conductivity σ of the conductive plate 2 is, for example, 6.66·10⁶ S/m and the relative permeability μᵣ is, for example, 200. A phase current of, for example, 1000 A RMS (root mean square) with a frequency of 50 Hz runs through the busbars 3.

For the two-dimensional optimization problem, the magnetic shunt 1′ is considered as rectangular in top view with its area being exemplarily divided into six times five, i.e., into thirty, identical rectangular parts 1″. As the magnetic shunt shall be symmetrical along the symmetry axis 8, each possible magnetic shunt topology can be represented by a bit string with 15 bits and the topology optimization problem turns into a binary optimization problem. For the details of this binary optimization problem, we refer to B. Cranganu-Cretu, J. Smajic, W. Renhart, Ch. Magele, “Software Integrated Solution for Design Optimization of Industrial Devices”, IEEE Transactions on Magnetics, Vol. 44, No. 6, pp. 1122-1125, June 2008; and J. Smajic, B. Cranganu-Cretu, A. Köstinger, M. Jaindl, W. Renhart, Ch. Magele, “Optimization of Shielding Devices for Eddy-Currents Using Multiobjective Optimization Methods”, Proceedings 13th Biennial IEEE Conference on Electromagnetic Field Computation (CEFC 2008), pp. 506, National Technical University of Athens, Greece, May 2008.

FIGS. 1 to 10 show the best of the all together 32768 (=2¹⁵) solutions to this binary optimization problem, wherein the quality of the solution is judged by the total power losses in the conductive plate 2 due to eddy-currents induced by the magnetic field. The smaller the induced power losses are, the better is the magnetic shielding achieved by the respective magnetic shunt. Without any magnetic shunt or magnetic shielding whatsoever, the busbars 3 will induce power losses of 8.29 W in total in the conductive plate 2. On the other hand, if the magnetic shunt 1′ includes all of the rectangular parts 1″ (corresponding to the bit string 111111111111111), thereby forming a massive rectangular magnetic shunt, then the induced power losses are 2.89 W.

The ten best solutions depicted in FIGS. 1 to 10 all include magnetic flux collectors at the end of a bridge of the magnetic shunt, with the cross-section of each of the magnetic flux collectors being larger than the cross-section of the bridge, thereby forming a lump piece of magnetic material. The magnetic shunts depicted in FIGS. 1 to 10 have a better shielding performance (less power losses) while requiring less material than the solid/massive rectangular magnetic shunt 1′ that include all rectangular parts 1″ due to the effect of the magnetic flux collectors. The global optimum solution depicted in FIG. 1 requires 55% less material and has 14% less induced power losses when compared with the obvious solution of a rectangular magnetic shunt 1′ with all shunt parts 1″.

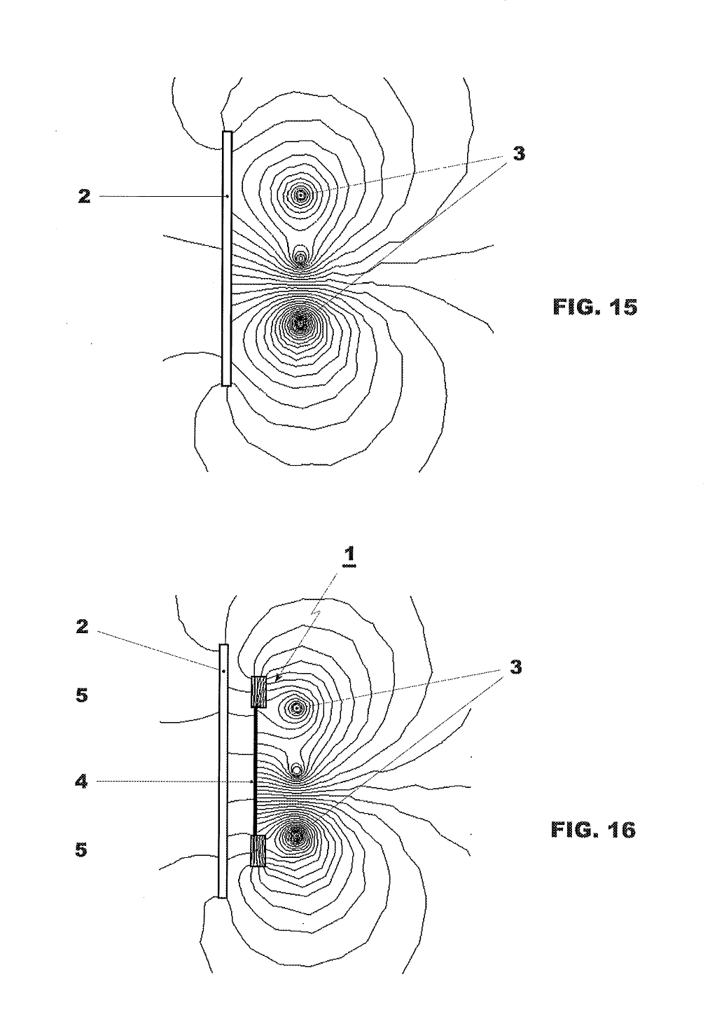

A magnetic flux collector forms a lump piece of magnetic material that simply attracts the magnetic flux from the environment around. The attracted magnetic flux is then conducted by the bridge with the smaller cross-section from its one end to its other end, where the magnetic flux then leaves the magnetic shunt on the surface of the other lump piece of magnetic material given by the other magnetic flux collector. This can also be seen from FIGS. 15 and 16, where FIG. 15 shows the magnetic flux lines (e.g., the real part of the magnetic vector potential Az) in the device with no magnetic shielding and total induced power losses of 8.29 W, and FIG. 16 shows the magnetic flux lines in the device with magnetic shielding in form of a magnetic shunt 1 with magnetic flux collectors 5 and a bridge 4 as depicted in FIGS. 1 and 11-13 with total induced power losses of 2.48 W.

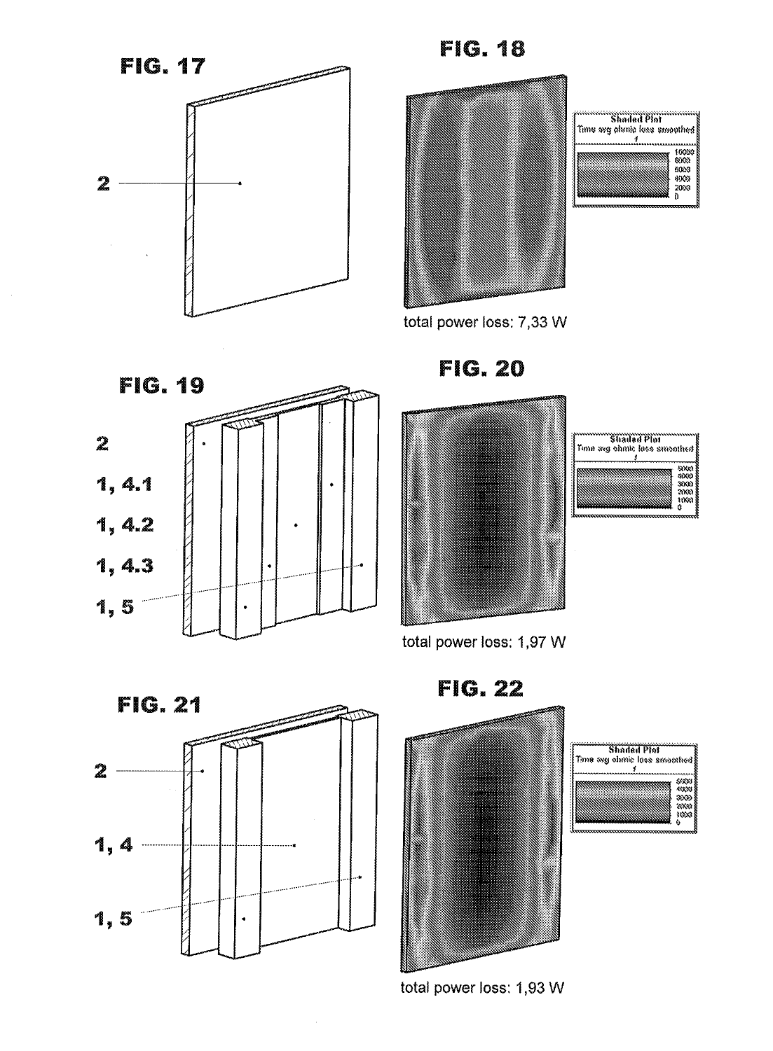

FIGS. 17, 19 and 21 each show a schematic representation of a tank wall 2 in which power losses are induced by stray magnetic flux of busbars (non-depicted). Dimensions and properties are as described for FIGS. 11-13, and the electrical current through the busbars is chosen as described for FIGS. 1 to 10. In FIG. 17, no magnetic shielding is provided. In FIG. 19, the magnetic shunt shown in FIG. 9 is used for magnetic shielding, and in FIG. 21, the magnetic shunt shown in FIG. 1 is used for magnetic shielding. FIGS. 18, 20 and 22 depict the simulated power losses induced in the tank wall 2 for each respective three-dimensional configuration. The configuration of FIG. 17 with no magnetic shielding yields a total power loss of 7.33 W. The configuration of FIG. 19 with the magnetic shunt of FIG. 9 yields a power loss of 1.97 W, which corresponds to a reduction of 11.7% of the power loss with 53% less magnetic shunt volume when compared to a configuration with a massive magnetic shunt, that is, with a magnetic shunt 1′ including all rectangular parts 1″ (in three dimensions: cuboidal or parallelepiped parts, respectively) as described above. The configuration with the massive magnetic shunt yields a total power loss of 2.33 W. The configuration of FIG. 21 with the magnetic shunt of FIG. 1 yields a power loss of 1.93 W, which corresponds to a reduction of 13.3% of the power losses with 53% less magnetic shunt volume when compared to a configuration with a massive magnetic shunt. Thus, with the magnetic shunts according to the exemplary embodiments of the present disclosure, less power losses can be obtained with less shunt material.

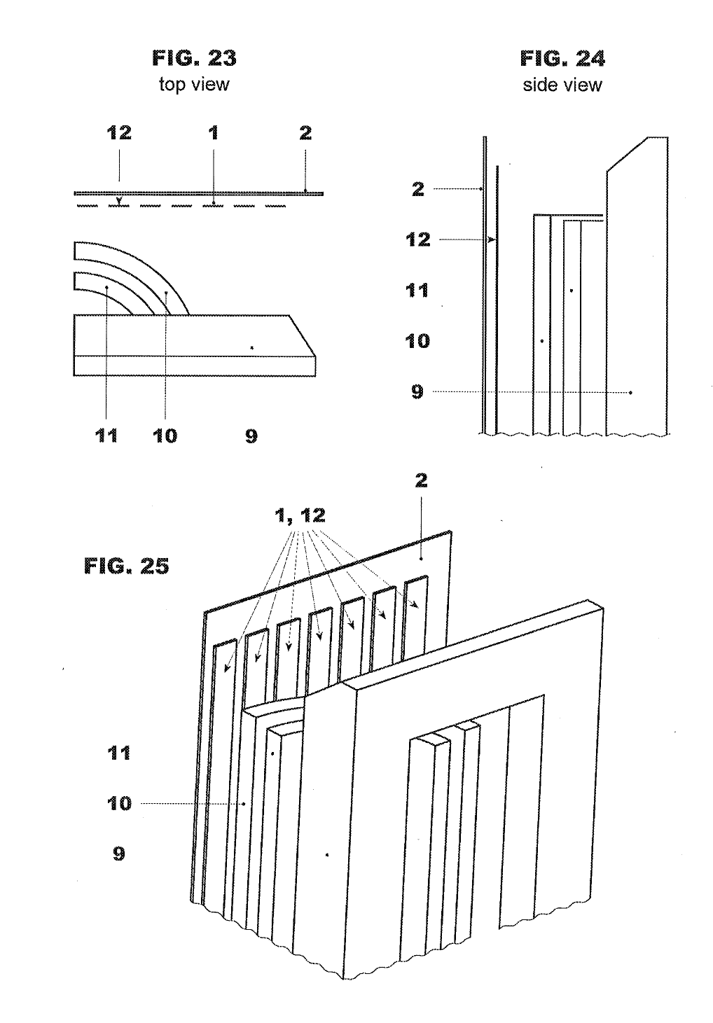

FIGS. 23-25 schematically show a partial representation of a power transformer with magnetic shunts 1 in top view (FIG. 23), in side view (FIG. 24) and in perspective view (FIG. 25). As the power transformer is symmetrical with respect to the planes perpendicular to its axes, only one eighth of the power transformer has been depicted. The power transformer includes a tank with the depicted tank wall 2 that is given by a ferromagnetic conductive plate, a magnetic core 9 and a winding that includes the primary coil 10 and the secondary coil 11, where the secondary coil 11 is surrounded by the primary coil 10. The primary coil 10 and the secondary coil 11 produce the magnetic field. The primary coil 10 has, for example, 24000 ampere-turns, and the secondary coil 11 has, for example, −20000 ampere-turns with the artificial unbalance in the ampere-turns accounting for the core magnetization flux. The frequency of the energizing current is, for example, 50 Hz. The main part of the magnetic flux is absorbed and guided by the magnetic core 9. Stray magnetic flux is generated partially because of core saturation and partially because of the air gap between the magnetic core 9 and the coils 10, 11. Between the windings, for example, the primary coil 10, and the tank wall 2 there is placed a magnetic shunt arrangement 12 for magnetic shielding that includes magnetic shunts 1 to reduce the power losses due to eddy currents induced in the tank wall 2 by the stray magnetic field. The material properties (e.g., electrical conductivity and magnetic permeability) of the magnetic shunts 1 and of the tank wall 2 are, for example, the same as given in connection with FIGS. 1 to 10. The material of the magnetic core 9 can be, for example, the same as the material of the magnetic shunts 1.

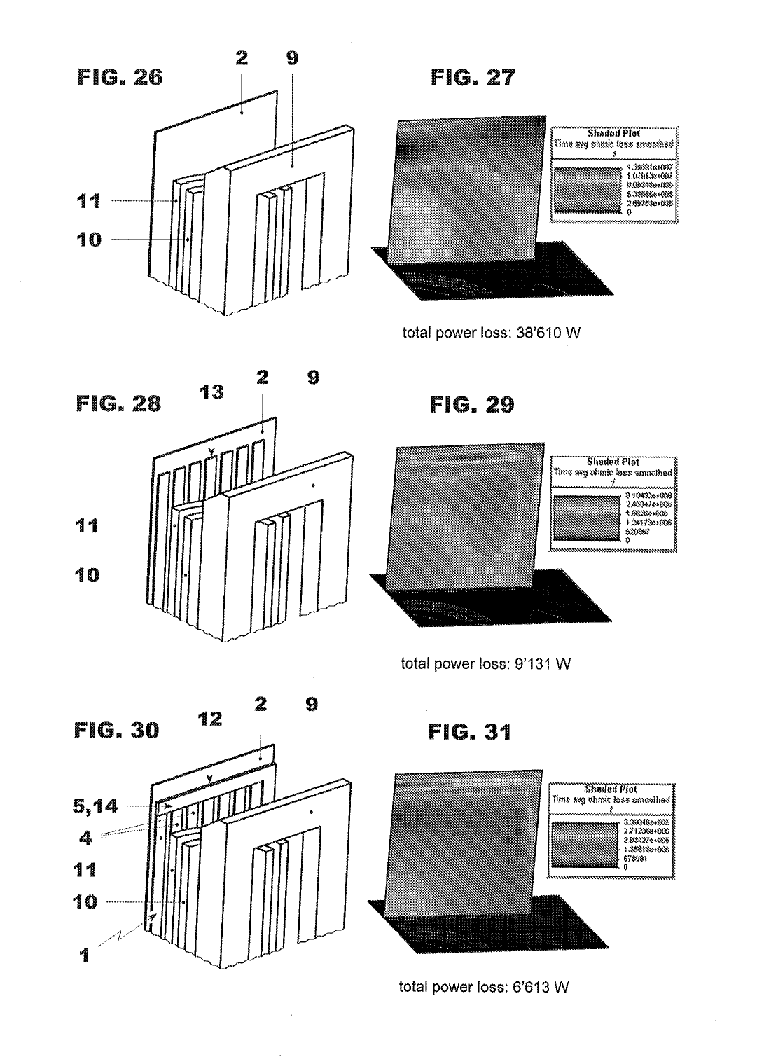

FIGS. 26, 28 and 30 each schematically show a partial representation of a power transformer (one eighth as in FIGS. 23-25), with power losses being induced in its tank wall 2 through stray magnetic flux produced by the windings 10, 11. Dimensions, properties and energizing current are as described for FIGS. 23-25. In FIG. 26, no magnetic shielding is provided. In FIG. 28, a known magnetic shunt arrangement 13 is used that consists of massive magnetic shunts 1′ as described above, that is, each magnetic shunt is given by a parallelepiped, with the magnetic shunts being arranged in a single row and with the longitudinal axes of the magnetic shunts being parallel to the expected stray magnetic flux (see K. Karsai, D. Kerenyi, L. Kiss, “Large Power Transformers”, Elsevier, Amsterdam—Oxford—New York, 1987).

In FIG. 30, the magnetic shunt arrangement 12 that is used for magnetic shielding includes the magnetic shunts 1 shown in FIG. 1. The magnetic shunts 1 are arranged in a single row with each magnetic flux collector 5 being connected to the magnetic flux collector of the adjacent magnetic shunt that is located at the same end of the bridge, the magnetic flux collectors 5 thereby forming a closed frame 14 of the magnetic shunt arrangement 12 that can have no gaps/interruptions. The bridges 4 of the adjacent magnetic shunts are spaced apart. In accordance with an exemplary embodiment, the longitudinal axes of the magnetic shunts 1 of the magnetic shunt arrangement 12 are parallel to the expected stray magnetic flux. The closed frame-collector 14 as illustrated in FIG. 30 is the exemplary realization of such a closed frame 14 implementing one of the different bridge 4 and collector 5 concepts provided in the exemplary embodiments in FIGS. 1 to 10. In FIG. 30, the magnetic stray flux is collected on all the sides primarily by means of this frame 14 and then it goes into the bridges. The top and bottom parts of the frame are capturing the stray flux from the ends of the windings, whereas the sides of the frame also capture flux from the busbars. Such a closed frame 14 magnetic shunt arrangement can be used, for example, for effective magnetic shielding of power device as transformers, such as power transformers, for example.

FIGS. 27, 29 and 31 depict the simulated power losses induced in the tank wall 2 of each respective three-dimensional power transformer configuration. For the tree-dimensional analysis of the eddy currents, the software Infolytica has been used. The power transformer of FIG. 26 with no magnetic shielding yields a total power loss of 38610 W. The power transformer of FIG. 28 with the known magnetic shunt arrangement 13 yields the smaller total power loss of 9131 W. The power transformer of FIG. 30 with the magnetic shunt arrangement 12 according to an exemplary embodiment of the present disclosure yields an even smaller total power loss of 6613 W, thereby leading to a further reduction of the power loss by 28%. Compared with a solid plate of magnetic material with theoretically zero electrical conductivity being used for magnetic shielding, the magnetic shunt arrangement 12 according to an exemplary embodiment of the present disclosure yields only 8% more power loss, but with a requirement for 35% less material.

The magnetic shunt arrangement 12 and its frame 14 are rather simple in construction. The frame 14 is made from magnetic material. In accordance with an exemplary embodiment, the frame 14 can be massive, for example, it has no interruptions or gaps. The magnetic shunt arrangement 12 can be realized by using known massive parallelepiped magnetic shunts and additional slightly thicker massive parallelepiped magnetic shunts which are placed at or about a right angle above the ends of the known massive parallelepiped magnetic shunts. The frame 14 can also be formed by using a couple of known massive parallelepiped magnetic shunts put together. Thus, an existing, known magnetic shunt arrangement 13 can be easily and feasibly modified to form the magnetic shunt arrangement 12 of the present disclosure by adding the frame 14.

It is to be understood that while certain embodiments of the present disclosure have been illustrated and described herein, it is not to be limited to the specific embodiments described and shown.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE NUMERALS

1 :magnetic shunt
1′: initial magnetic shunt for optimization
1″: parts of the magnetic shunt 1′
2: conductive ferromagnetic plate
3: busbars, source of magnetic field
4: bridge
4.1: outermost section of the bridge
4.2: inner section of the bridge
4.3: outermost section of the bridge
5: magnetic flux collector
5.1: part of the magnetic flux collector
6: gap
7: gap
8: symmetry axis
9: magnetic core
10: primary coil
11: secondary coil
12: magnetic shunt arrangement
13: known magnetic shunt arrangement
14: frame
15: laminated structure

What is claimed is:

1. A magnetic shunt for magnetic shielding of a power device, comprising:
magnetic flux collectors; and
a magnetically permeable bridge configured to magnetically connect the magnetic flux collectors and form the magnetic shunt as a single structural unit, wherein:
the bridge is arranged between the magnetic flux collectors with one magnetic flux collector being placed at each end of the bridge, respectively,
a cross-section of the magnetic flux collectors is larger than a cross-section of the bridge; and
the magnetic shunt is substantially concave towards magnetic field sources.

2. The magnetic shunt according to claim 1, wherein the magnetic flux collectors and the bridge are at least partially made with the same magnetic material.

3. The magnetic shunt according to claim 1, wherein the magnetic flux collectors are aligned with the bridge.

4. The magnetic shunt according to claim 1, wherein the bridge includes at least three sections having at least one inner section and two outermost sections,
wherein the two outermost sections are each being located at an end of the bridge and have a larger cross-section than the at least one inner section.

5. The magnetic shunt according to claim 4, wherein the two outermost sections are aligned with the at least one inner section.

6. The magnetic shunt according to claim 1, wherein the bridge includes at least three sections having at least one inner sections and two outermost sections,
wherein the at least one inner section is shifted sideways with respect to the two outermost sections, and each outermost section is located at an end of the bridge.

7. The magnetic shunt according to claim 1, wherein the magnetic flux collectors each comprise at least one longitudinal gap.

8. The magnetic shunt according to claim 1, wherein the magnetic flux collectors form a closed frame surrounding the bridge.

9. A magnetic shunt arrangement for magnetic shielding of a power device, comprising:
at least two magnetic shunts according to claim 1,
wherein the magnetic shunts are arranged in a single row with corresponding bridges spaced apart, and each magnetic flux collector is connected to the magnetic flux collector of an adjacent magnetic shunt that is located at a corresponding end of the respective bridge.

10. A power device comprising:
a magnetic core;
a winding inductively coupled to the magnetic core;
a tank with tank walls; and
at least one magnetic shunt according to claim 1, the at least one magnetic shunt being arranged such that a corresponding bridges of the at least one magnetic shunt runs in parallel and is at the same distance to at least one of the tank walls.

11. The power device according to claim 10, comprising at least two magnetic shunts, wherein for at least one of the magnetic shunts, the corresponding bridge is centered between the magnetic flux collectors in a transverse direction, and for at least one other one of the magnetic shunts, the corresponding bridge is shifted towards the tank wall.

12. The power device according to claim 10, wherein the magnetic flux collectors are aligned with the corresponding bridge for at least one magnetic shunt, and
wherein a side of the aligned at least one magnetic shunt faces the tank wall.

13. The power device according to claim 10, wherein for at least one magnetic shunt, the bridge includes at least three sections having at least one inner section and two outer sections,
wherein the at least one inner section is shifted closer towards the tank wall than the two outermost sections, and each outermost section is located at an end of the corresponding bridge.

14. The power device according to claim 10, wherein for at least one magnetic shunt, the bridge includes at least three sections having at least one inner section and two outermost sections,
wherein each of the two outermost sections is located at an end of the bridge, and has a larger cross-section than the at least one inner section, and
wherein the two outermost sections are aligned with the at least one inner section with the aligned sections facing the tank wall.

15. The power device according to claim 10, wherein for at least one magnetic shunt, the bridge includes at least three sections having at least one inner section and two outermost sections,
wherein each of the outermost sections is located at an end of the bridge, and has a larger cross-section than the at least one inner section, and
wherein the two outermost sections are aligned with the at least one inner section with the aligned sections facing away from the tank wall.

16. The magnetic shunt according to claim 1, wherein a cross-section of the magnetic flux collectors is at least 10 times larger than a cross-section of the bridge.

17. The magnetic shunt according to claim 1, wherein a laminated structure of the bridge extends into a region of the magnetic flux collectors.

18. The magnetic shunt according to claim 1, wherein a direction of a laminated structure in the bridge is oriented orthogonal to a direction of at least a part of a laminated structure of the bridge.

19. The magnetic shunt according to claim 1, wherein the power device is a power transformer.

20. The magnetic shunt according to claim 2, wherein the magnetic flux collectors are aligned with the bridge.

21. The magnetic shunt according to claim 3, wherein the bridge includes at least three sections having at least one inner section and two outermost sections,
wherein the two outermost sections are each being located at an end of the bridge and have a larger cross-section than the at least one inner section.

22. The magnetic shunt according to claim 21, wherein the two outermost sections are aligned with the at least one inner section.

23. The magnetic shunt according to claim 3, wherein the bridge includes at least three sections having at least one inner sections and two outermost sections,
wherein the at least one inner section is shifted sideways with respect to the two outermost sections, and each outermost section is located at an end of the bridge.

24. The magnetic shunt according to claim 4, wherein the magnetic flux collectors each comprise at least one longitudinal gap.

25. The magnetic shunt according to claim 6, wherein the magnetic flux collectors each comprise at least one longitudinal gap.

26. The magnetic shunt according to claim 2, wherein the magnetic flux collectors form a closed frame surrounding the bridge.

27. The magnetic shunt according to claim 17, wherein a direction of a laminated structure in the bridge is oriented orthogonal to a direction of at least a part of the laminated structure of the bridge.

28. The magnetic shunt arrangement according to claim 9, wherein the power device is a power transformer.

29. A magnetic shunt arrangement for magnetic shielding of a power device, comprising:
at least two magnetic shunts according to claim 4,
wherein the magnetic shunts are arranged in a single row with corresponding bridges spaced apart, and each magnetic flux collector is connected to the magnetic flux collector of an adjacent magnetic shunt that is located at a corresponding end of the respective bridge.

30. A magnetic shunt arrangement for magnetic shielding of a power device, comprising:
at least two magnetic shunts according to claim 6,
wherein the magnetic shunts are arranged in a single row with corresponding bridges spaced apart, and each magnetic flux collector is connected to the magnetic flux collector of an adjacent magnetic shunt that is located at a corresponding end of the respective bridge.

31. A power device comprising:
a magnetic core;
a winding inductively coupled to the magnetic core;
a tank with tank walls; and
at least one magnetic shunt according to claim 4, the at least one magnetic shunt being arranged such that a corresponding bridge of the at least one magnetic shunt runs in parallel and is at the same distance to at least one of the tank walls.

32. A power device comprising:
a magnetic core;
a winding inductively coupled to the magnetic core;
a tank with tank walls; and
at least one magnetic shunt according to claim 6, the at least one magnetic shunt being arranged such that a corresponding bridge of the at least one magnetic shunt runs in parallel and is at the same distance to at least one of the tank walls.

33. A power device comprising:
a magnetic core;
a winding inductively coupled to the magnetic core;
a tank with tank walls; and
a magnetic shunt arrangement according to claim 9, wherein at least one magnetic shunt of the magnetic shunt arrangement is arranged such that a corresponding bridge of the at least one magnetic shunt runs in parallel and is at the same distance to at least one of the tank walls.

34. The power device according to claim 11, wherein the magnetic flux collectors are aligned with the corresponding bridge for at least one magnetic shunt, and
wherein a side of the aligned at least one magnetic shunt faces the tank wall.

35. The power device according to claim 12, wherein for at least one magnetic shunt, the bridge includes at least three sections having at least one inner section and two outermost sections,
wherein each of the two outermost sections is located at an end of the bridge, and has a larger cross-section than the at least one inner section, and
wherein the two outermost sections are aligned with the at least one inner section with the aligned sections facing the tank wall.

36. The power device according to claim 12, wherein for at least one magnetic shunt, the bridge includes at least three sections having at least one inner section and two outermost sections,
wherein each of the outermost sections is located at an end of the bridge, and has a larger cross-section than the at least one inner section, and
wherein the two outermost sections are aligned with the at least one inner section with the aligned sections facing away from the tank wall.

37. The power device according to claim 33, wherein for at least one magnetic shunt, the bridge includes at least three sections having at least one inner section and two outermost sections,
wherein each of the two outermost sections is located at an end of the bridge, and has a larger cross-section than the at least one inner section, and
wherein the two outermost sections are aligned with the at least one inner section with the aligned sections facing the tank wall.

38. The power device according to claim 33, wherein for at least one magnetic shunt, the bridge includes at least three sections having at least one inner section and two outermost sections,
wherein each of the outermost sections is located at an end of the bridge, and has a larger cross-section than the at least one inner section, and
wherein the two outermost sections are aligned with the at least one inner section with the aligned sections facing away from the tank wall.
